(19) United States
(12) Patent Application Publication
(10) Pub. No.: US 2010/0314467 A1
(43) Pub. Date: Dec. 16, 2010

(54) THERMAL SPRAYING METHOD AND DEVICE

(75) Inventors: Jan Wigren, Trollhattan (SE); Jimmy Johansson, Trollhattan (SE); Stefan Björklund, Trollhattan (SE); Isabelle Choquet, Trollhattan (SE)

Correspondence Address: WRB-IP LLP, 801 N. Pitt Street, Suite 123, ALEXANDRIA, VA, 22314, US

(73) Assignees: VOLVO AERO CORPORATION, Trollhattan (SE); Hogskolan Trollhattan/Uddevalla Inst. for Teknik, Trollhanttan (SE)

(21) Appl. No.: 12/868,333

(22) Filed: Aug. 25, 2010

Related U.S. Application Data
(62) Division of application No. 11/813,226, filed on Jul. 2, 2007.

(51) Int. Cl. B05C 5/04; C23C 4/12

(52) U.S. Cl. 239/79

(57) ABSTRACT

A thermal spraying device includes an arrangement for generating a flame and an arrangement for injecting a powder into the flame, the flame-generating means including an end piece out of an outlet of which the flame is directed towards a substrate subjected to spraying, and the powder-injection arrangement includes a frame element that projects in the flame ejection direction from the end piece, that at least partly surrounds a flame zone extending from the end piece, and that presents an inner circumference that is larger than the inner circumference of the outlet, and at least one powder port for the introduction of a powder to the flame being arranged on the inner periphery of the frame element at a distance from the outlet of the end piece as seen in the flame ejection direction. There is provided at least one gas injection opening in the frame element, the gas injection opening being located between the outlet of the end piece and the at least one powder port as seen in the flame ejection direction.

The present application is a divisional of U.S. application Ser. No. 11/813,226, filed Jul. 2, 2007, which is the U.S. National stage application of PCT/SE2005/000102, filed Jan. 26, 2005.

### BACKGROUND AND SUMMARY

An aspect of the present invention relates to a thermal spraying method, by which a flame is generated and ejected out through an outlet of an end piece of a thermal spraying device into a space in which it is at least partly surrounded by a frame element that projects in the flame ejection direction, and by which a powder is injected into the flame from at least one port provided at the inner periphery of said frame at a distance from said outlet as seen in the flame ejection direction, said frame having a larger inner circumference than that of said outlet.

An aspect of the invention also relates to a thermal spraying device, comprising a means for generating a flame and a means for injecting a powder into the flame, said flame-generating means comprising an end piece out of an outlet of which the flame is directed towards a substrate subjected to spraying, and the powder-injection means comprising a frame element that projects in the flame ejection direction from the end piece, that at least partly surrounds a flame zone extending from the end piece, and that presents an inner circumference that is larger than the inner circumference of said outlet, and at least one powder port for the introduction of a powder to the flame being arranged on the inner periphery of said frame element at a distance from the outlet of the end piece as seen in the flame ejection direction.

“Thermal spraying device” is referred to as any device for generating a flame that can be used for the purpose of depositing a coating of metal or ceramic onto a substrate, and may include plasma spraying guns of different kinds, flame jet devices, HVOF devices, et cetera.

The technical field of the invention is particularly that of applying coatings, such as thermal barrier coatings of metal or ceramics, onto substrates, in particular onto substrates such as constructional elements in aero space constructions, in particular motor parts thereof. However, the invention is not restricted to such applications, but could find a number of applications outside this relatively narrow field.

Prior art devices for plasma spraying a powder onto a substrate comprises a plasma jet-generating means and one or more powder injection ports via which a powder is injected to the plasma jet.

A conventional such plasma jet gun, for example the widely used F4 Sulzer Metco gun, comprises an end piece through which the plasma jet is directed out of the gun and towards the substrate that is to be coated. A shoulder or knob provided with a nozzle for injection of a powder towards and into the plasma jet is attached to the end piece.

During operation, when the powder is injected into the plasma jet, melted and deposited onto a substrate, characteristic flow patterns are generated as the powder reaches the jet. Often, during normal operation conditions, a back-stream of powder may return to the nozzle, resulting in the clogging thereof. Larger particles of aggregated powder clogged in the nozzle or the end piece will sooner or later get loose and ejected into the jet, thereby causing disturbances in the spraying process, resulting in blisters and lumps being generated in the coating.

Swedish patent application SE 0202765-4, filed by the applicant, discloses the use of through holes in the frame element of a thermal spraying device. The through holes may or may not accommodate a powder injection port or nozzle, and they are provided at equal axial position on the frame element. The holes that do not accommodate a powder injection nozzle contribute to a radial communication between the interior an exterior sides of the ring. Normally, the exterior comprises air atmosphere, and the holes act as air cooling holes that further stabilise the jet and also counteract powder back-flow towards the nozzles. However, no active injection of gas or air is suggested, and the location of the holes results in a delimited effect as to the prevention of clogging of the end piece.

It is desirable to present a thermal spraying method and device for which the tendency of having unfavourable back-streams of powder with a resulting clogging of nozzles is reduced or even eliminated.

According to an aspect of the present invention, gas is injected into said space from the inner periphery of said frame, in a region between the outlet of the end piece and the powder port as seen in the flame ejection direction. Thereby, a flowing layer of pressurized gas is provided in vicinity of an end surface of the end piece, more precisely the surface that surrounds the end piece outlet. The gas layer will prevent the upcoming of back-streams of powder and the associated clogging of said end surface.

According to an aspect of the invention, the gas is injected at a plurality of different locations around the inner circumference of the frame, in order to achieve an evenly covering gas layer. Preferably gas is injected in a direction to generate a gas layer in the vicinity of the end wall surface of the end piece that surrounds said outlet.

When the flame is centrally located in said space, then the gas is preferably injected in a non-radial direction into said space, in order to prevent the gas from being injected straight into the flame and disturbing the same. Accordingly, it is preferred that the gas is injected in a direction towards the vicinity of the outer periphery of flame. Since it can be assumed that the flame will have a cross-sectional dimension similar to the one of the end piece outlet, the gas is preferably injected in a direction towards the vicinity of the outer periphery of a projection of the end piece outlet in said space.

Preferably the gas is argon, air or any other gas or gas mixture that is not prone to interact with or disturb the flame.

According to an aspect of the present invention, a thermal spraying device has at least one gas injection opening in the frame element, said gas injection opening being located between the outlet of the end piece and the at least one powder port as seen in the flame ejection direction.

An aspect of the invention also relates to a frame element for a thermal spraying device, comprising a first end surface for attachment to the end surface of an end piece of said thermal spraying device, and at least one powder port for the introduction of a powder, said port being provided on the inner periphery of said frame element at a distance from said first end surface, characterised in that there is provided at least one gas injection opening in the frame element, said gas injection opening being located between said first end surface and the at least one powder port.

According to an aspect of the invention the flame generated by the flame-generating means is a plasma jet, formed by letting a gas flow in an annular path between a cathode and an anode. Typically, the temperature of such a jet can reach 15 000° C. and the powder introduced into the plasma can obtain a speed of up to 500 m/s as it is melted and accelerated by the plasma jet before hitting a substrate. The gas injected via the inventive gas injection opening, as described above, is separate from the plasma-forming gas.

Further features and advantages of the present invention will be presented in the following detailed description.

### BRIEF DESCRIPTION OF THE DRAWINGS

A preferred embodiment of the present invention will now be described with reference to the annexed drawings on which:

FIG. 1 is a perspective view of a frame element according to the invention,

FIG. 2 is an end view of the frame element of FIG. 1, and

FIG. 3 is a partially cut side view of a typical plasma spraying device according to the invention.

### DETAILED DESCRIPTION

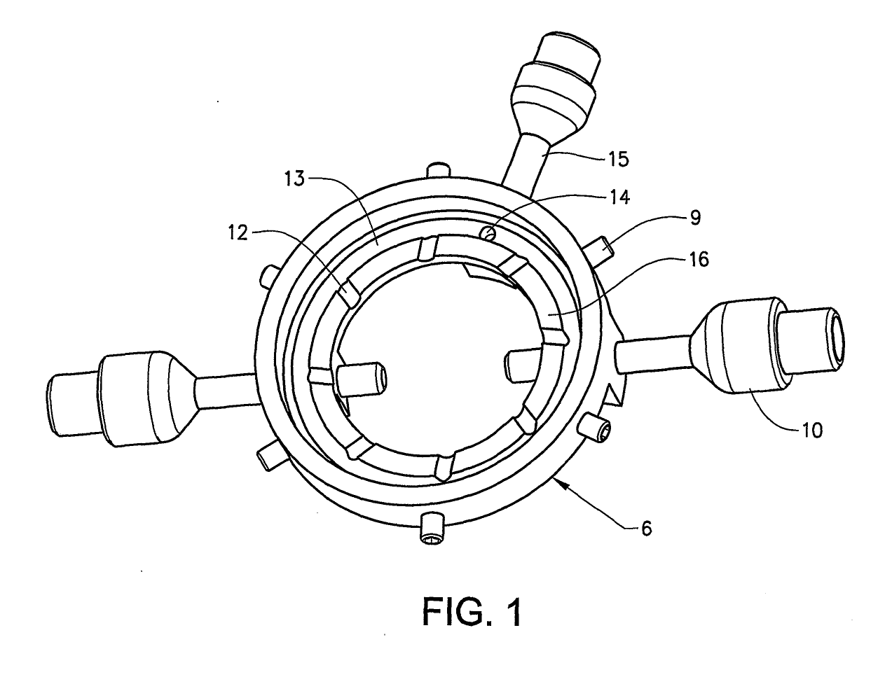

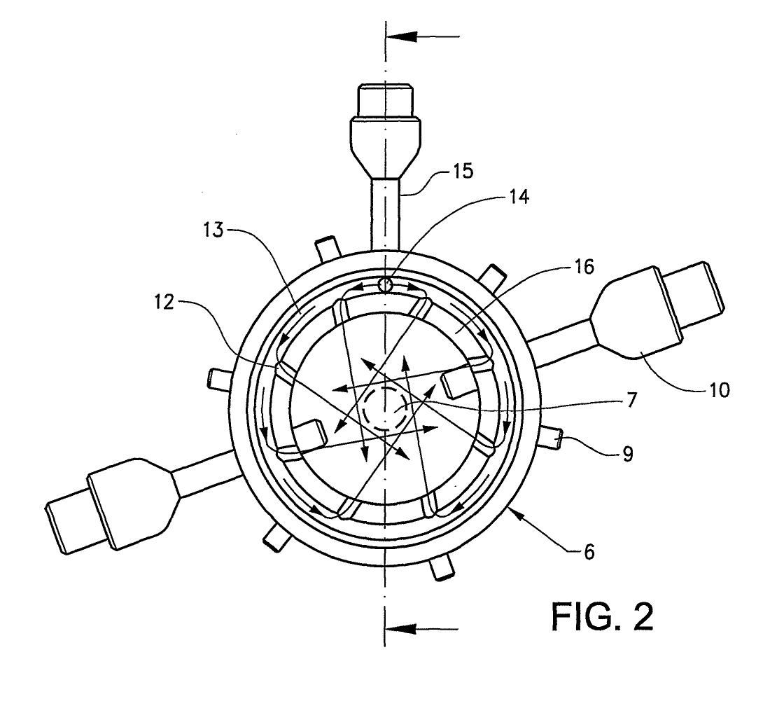

FIGS. 1 and 2 shows a frame element 2 forming a part of a thermal spraying device according to an aspect of the invention.

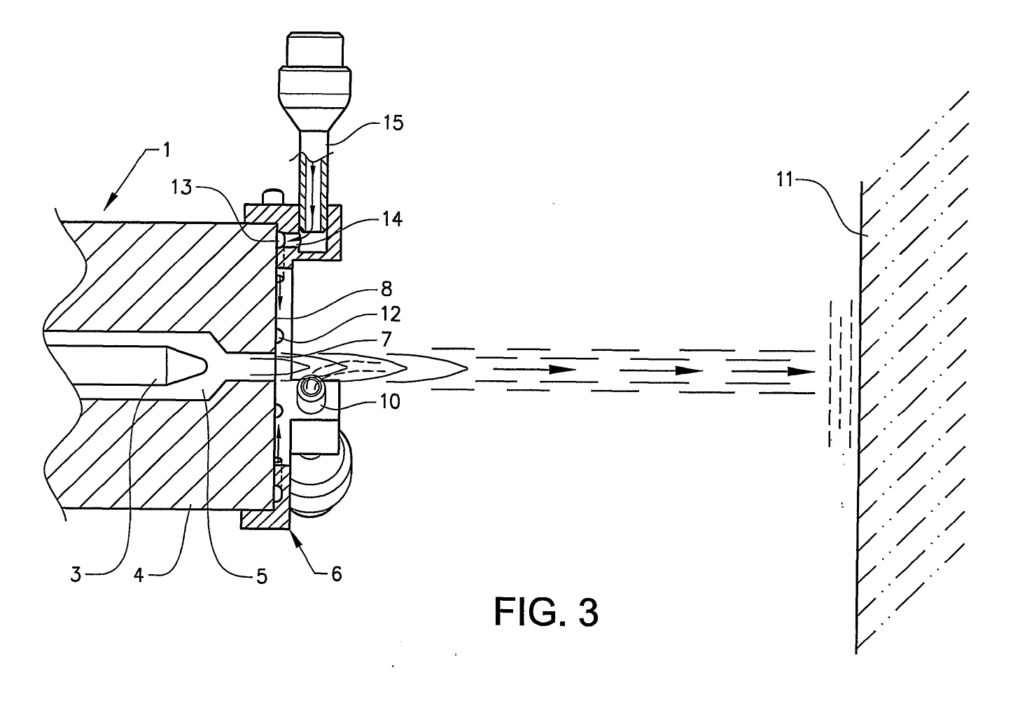

FIG. 3 shows a thermal spraying device, more precisely a plasma spraying device, according to the invention, provided with an end piece 1 and a powder injection means that comprises a frame element 2, attached to the end of the end piece 1 and forming a prolongation thereof, however of substantially larger inner radius. Further, the device comprises means 3,4 for generating a flame, here a plasma jet. Such means includes a cathode 3 and an anode 4, as shown in FIG. 3, arranged in a way known per se and defining an annular path 5 between them. The end piece 1 comprises a tube with circular cross section that may also form the anode 4. The end piece presents a flame outlet 7.

The frame element 2 is formed by one single, continuous ring. The ring 2 is detachably attached to and projects a distance beyond an annular end surface 8 of the end piece 1 in the plasma jet direction. The frame element 2, is adapted to be pulled onto the end of the end piece 1 and fixed in position by means of fixation screws 9. Other connection means, such as clamps or the like, could be used as an alternative

On the frame element 2 there are provided one or more powder injection ports 10, protruding through radial holes in the wall of the frame element 2, and provided for the purpose of supplying a powder of a material to be at least partly melted by the plasma jet and deposited on a substrate, indicated with 11 in FIG. 3. Here, each port 10 protrudes through a knob or ring segment 6 that, in its turn, protrudes from the annular part of the frame element in the flame ejection direction.

As can be seen in all figures there is provided at least one gas injection opening 12 in the frame element 2, said gas injection openings 12 being located between the outlet 7 of the end piece 1 and the at least one powder port 10 as seen in the flame ejection direction. Preferably the gas injection openings are in communication with any kind of means for the supply of pressurised gas thereto, in order to provide for an introduction of pressurised gas in the space adjacent to the end surface 8 of the end piece 1.

The at least one gas injection opening 12 is directed in a non-radial direction. Here, each gas injection opening 12 is directed such that a prolongation thereof will extend to the vicinity of the periphery of a projection of said outlet 7 in said space. This can be seen more clearly in FIG. 2. Preferably, the gas injection openings are directed such that a prolongation thereof will extend to the vicinity of the outer periphery of the flame to be generated in said space. According to the invention, the direction of the injection opening 12 is such as to direct the gas into a spacing between the flame and the inner periphery of the frame element 2 in order to avoid any direct interaction between the gas and the flame or jet.

As can be seen, the device comprises a plurality of gas injection openings 12 that are angularly distributed along the inner circumference of the frame 6. Preferably, the gas injection openings 12 are evenly angularly distributed on the inner circumference of the frame. Preferably, there are more than 4 openings 12.

Each opening 12 is connected to a common channel 13 which, in its turn is connected, via a through hole 14 in the frame element wall, to a port 15 or the like for the supply of pressurised gas. Here, the openings 12 and the channel 13 is defined by a groove arranged in an end surface 16 of the frame element 2, said end surface being adapted to bear sealingly against the end surface 8 of the end piece 1 when the frame element 2 is mounted thereto. Thereby, the groove will result in channels delimited by the end surface 8 of the end piece 1 and the surfaces of the groove in the frame element. Of course, the openings 12 could have some other design. For example, they could as well be formed by channels or through holes instead of grooves in the frame element 2. The gas distribution at the nozzle wall should be even. This cannot be obtained if the flow rate through the openings 12 is not even. To obtain even flow rates through the openings 12, suitable dimensions for all the channels (15, 13, 14, 12) are needed and in some cases the use of at least one additional port 15 may be required.

A particular advantage of the invention is that a frame element 2 as described above could be used to replace the single shoulder and nozzle arrangement of prior art on widely used plasma jet guns available on the market today, such as the F4 gun, without extensive work.

It should be realised that the above presentation of the invention has been made by way of example, and that alternative embodiments will be obvious for a man skilled in the art. However, the scope of protection claimed is defined in the patent claims supported by the description and the annexed drawings.

1. A thermal spraying method, by which
a flame is generated and ejected out through an outlet (7) of an end piece (1) of a thermal spraying device into a space in which it is at least partly surround by a frame element (2) that projects in the flame ejection direction,
and by which a powder is injected into the flame from at least one port provided at the inner periphery of said frame at a distance from said outlet (7) as seen in the flame ejection direction, said frame having a larger inner circumference than that of said outlet (7), and characterised in that gas is injected into said space from the inner periphery of said frame, in a region between the outlet (7) of the end piece (1) and the powder port (10) as seen in the flame ejection direction.

2. A thermal spraying device according to claim 1, characterised in that the gas is injected at a plurality of different locations around the inner circumference of the frame.

3. A thermal spraying device according to claim 1 or 2, characterised in that the gas is injected in a direction to generate a gas layer in the vicinity of an end wall surface of the end piece (1) that surrounds said outlet (7).

4. A thermal spraying method according to any one of claims 1-3, characterised in that the flame is centrally located in said space and that the gas is injected in a non-radial direction into said space.

5. A thermal spraying method according to any one of claims 1-4, characterised in that the gas is injected in a direction towards the vicinity of the outer periphery of flame.

6. A thermal spraying method according to any one of claims 1-5, characterised in that the gas is injected in a direction towards the vicinity of the outer periphery of a projection of the end piece (1) outlet (7) in said space.

7. A thermal spraying device, comprising a means for generating a flame and a means for injecting a powder into the flame, said flame-generating means comprising an end piece (1) out of an outlet (7) of which the flame is directed towards a substrate subjected to spraying, and the powder-injection means comprising a frame element (2) that projects in the flame ejection direction from the end piece (1), that at least partly surrounds a flame zone extending from the end piece (1), and that presents an inner circumference that is larger than the inner circumference of said outlet (7), and at least one powder port (10) for the introduction of a powder to the flame being arranged on the inner periphery of said frame element (2) at a distance from the outlet (7) of the end piece (1) as seen in the flame ejection direction, characterised in that there is provided at least one gas injection opening (12) in the frame element (2), said gas injection opening (12) being located between the outlet (7) of the end piece (1) and the at least one powder port (10) as seen in the flame ejection direction.

8. A thermal spraying device according to claim 7, characterised in that the frame element (2) is ring-shaped and that the at least one gas injection opening (12) is directed in a non-radial direction.

9. A thermal spraying device according to claim 8, characterised in that the at least one gas injection opening (12) is directed such that a prolongation thereof will extend to the vicinity of the periphery of a projection of said outlet (7) in said space,

10. A thermal spraying device according to any one of claims 7-9, characterised in that the at least one gas injection opening (12) is directed such that a prolongation thereof will extend to the vicinity of the outer periphery of the flame to be generated in said space.

11. A thermal spraying device according to any one of claims 7-10, characterised in that the direction of the injection opening (12) is such as to direct the gas into a spacing between the flame and the inner periphery of the frame.

12. A thermal spraying device according to any one of claims 7-11, characterised in that the frame element (2) is formed by a ring or a ring segment attached to the end piece (1) and forming a widened elongation of the latter.

13. A thermal spraying device according to any one of claims 7-12, characterised in that it comprises a plurality of gas injection openings (12) that are angularly distributed along the inner circumference of the frame element (2).

14. A thermal spraying device according to claim 13, characterised in that the gas injection openings (12) are evenly angularly distributed on the inner circumference of the frame element (2).

15. A thermal spraying device according to any one of claims 7-14, characterised in that the frame element (2) is detachably attached to the end piece (1).

16. A thermal spraying device according to any one of claims 7-15, characterised in that the flame generated by the flame-generating means is a plasma jet.

17. A frame element (2) for a thermal spraying device, comprising a first end surface (16) for attachment to the end surface (8) of an end piece (1) of said thermal spraying device, and at least one powder port (10) for the introduction of a powder, said port being provided on the inner periphery of said frame element (2) at a distance from said first end surface, characterised in that there is provided at least one gas injection opening (12) in the frame element (2), said gas injection opening (12) being located between said first end surface and the at least one powder port (10).

18. A frame element (2) according to claim 17, characterised in that the frame element (2) is ring-shaped and that the at least one gas injection opening (12) is directed in a non-radial direction.

19. A frame element (2) according to claim 17 or 18, characterised in that it comprises a plurality of gas injection openings (12) that are angularly distributed along the inner circumference of the frame element (2).

20. A frame element (2) according to claim 19, characterised in that the gas injection openings (12) are evenly angularly distributed on the inner circumference of the frame.

21. A frame element (2) according to any one of claims 17-20, characterised in that the at least one gas injection opening (12) is formed by a groove provided in said first end surface.

22. A frame element (2) according to any one of claims 17-21, characterised in that it is a plasma spray gun holder ring.
